(19) United States
(12) Patent Application Publication
(10) Pub. No.: US 2004/0079492 A1
(43) Pub. Date: Apr. 29, 2004

(54) Double-layer drape

(76) Inventor: Henry Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/277,675

(22) Filed: Oct. 23, 2002

(51) Int. Cl. E06B 9/06

(52) U.S. Cl. 160/84.01

(57) ABSTRACT

A double-layer drape includes an upper beam and a composition of window curtain to link to the upper beam. The composition of window curtain includes an inner layer and an outward one; both layers are formed by different shade cloths. The outward layer is a previous-to-light curtain; whereas the inner layer comprises a plurality of opaque curtains. The inner layer curtains are connected to the previous-to-light curtain by up-and-down overlapping, in addition, the opaque curtains can be simultaneously folded upwards or hung over downwards through pulling operating cords by a user to achieve the indoor anti-dazzling or semi-opaque effects.

### BACKGROUND OF THE INVENTION

(A) Field of Invention

The invention relates to a double-layer drape, especially a composition of window curtain, which comprises both inner and outer layers of shade curtains. The outward layer is a previous-to-light curtain; whereas the inner layer comprises a plurality of opaque curtains. The inner layer curtains are connected to the previous-to-light curtain by up-and-down overlapping, in addition, the opaque curtains can be simultaneously folded upwards or hung over downwards through pulling operating cords by a user to achieve the indoor anti-dazzling or semi-opaque effects.

(B) Description of Prior Art

Window curtains in modern living houses mainly provide the functions of sunshade and privacy protection. FIG. 1 shows a prior art window curtain 10 (roman shade), which comprises an upper beam 11 and a window curtain cloth 12 to be connected the bottom of the upper beam 11. One end of the upper beam 11 has an operating cord brake component 13, which allows an operating cord 14 to be pierced through dropping at one side of the window curtain cloth 12 for a user to pull the cord. The window curtain cloth 12 has several equidistant horizontal shade cloths 15, which are sewed and connected to one another. Each sewed shade cloth 15 has two holes 16 for enabling the operating cord 14 to pierce through to the lowest hole 16 to be fixed, therefore, through pulling the operating cord 14 by a user, the window curtain cloth 12 can be folded upwards or hung over downwards.

Hence, the window curtain cloth 12 provides the anti-dazzling function while being dropped; on the contrary, the window curtain cloth 12 has to be folded upwards when it requires the room to be lit up by shining the light through in the room. The kind of traditional unchangeable way of drape is no more fit in with the modern life function and requirement.

In view of the foregoing drawback of conventional draper, the invention mainly aims at providing a double-layer drape, which comprises an upper beam and a composition of window curtain to be connected with the upper beam. The composition of window curtain is formed by two kinds of curtain cloths of both inner and outer layers. The outward layer is a previous-to-light curtain; whereas the inner layer comprises a plurality of opaque curtains. The inner layer curtains are connected to the previous-to-light curtain by up-and-down overlapping, in addition, the opaque curtains can be simultaneously folded upwards or hung over downwards through pulling operating cords by a user to achieve the indoor anti-dazzling or semi-opaque effects. The composition of window curtain provides different two window curtain effects at one time for meeting the requirements of modern life functions; the draper of the invention offers the enrichment a variation in the fields of both operation and light control.

Another object of the invention is to provide a previous-to-light curtain of the double-layer drape that can be pulled by a set of operating cord to enable the previous-to-light curtain to be folded upwards or dropped downward to generate a completely well-lit effect in the room.

To enable a further understanding of the objective, structural features and function of the present invention, the detailed descriptions of the preferred embodiments are followed by the brief descriptions of the drawings below. However, it is to be understood that the disclosed embodiments are merely exemplary of the invention that may be embodied in various forms.

### BRIEF DESCRIPTION OF THE DRAWINGS

FIG. 1 is a perspective view of a conventional window curtain (roman shade).

FIG. 2 is a perspective view of the invention.

FIG. 3 is a partial perspective view of the invention.

FIG. 4 is a fragmentary view enlarged taken at line 4 of FIG. 3.

FIG. 5 is a fragmentary view enlarged taken at line 5 of FIG. 3.

FIG. 6 is a cross-sectional view taken along lines 6-6 of FIG. 2.

FIG. 7 is a cross-sectional view of the upwardly folded opaque curtain according to FIG. 6.

FIG. 8 is a perspective view of the upwardly folded opaque curtain according to FIG. 2.

FIG. 9 is a perspective view of the upwardly folded opaque curtain according to FIG. 2.

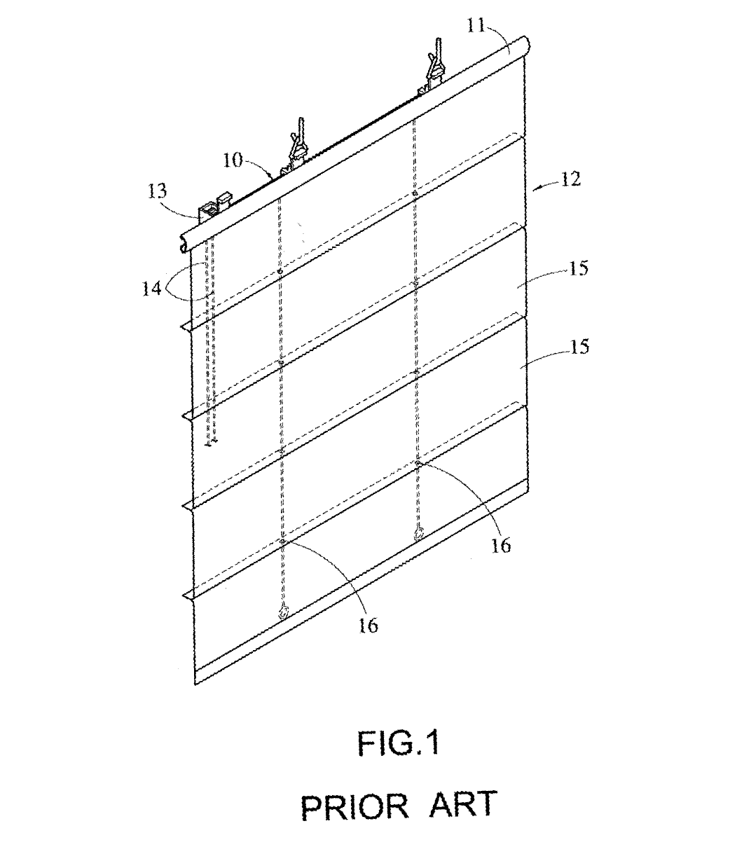

### DETAILED DESCRIPTION OF THE PREFERRED EMBODYMENTS

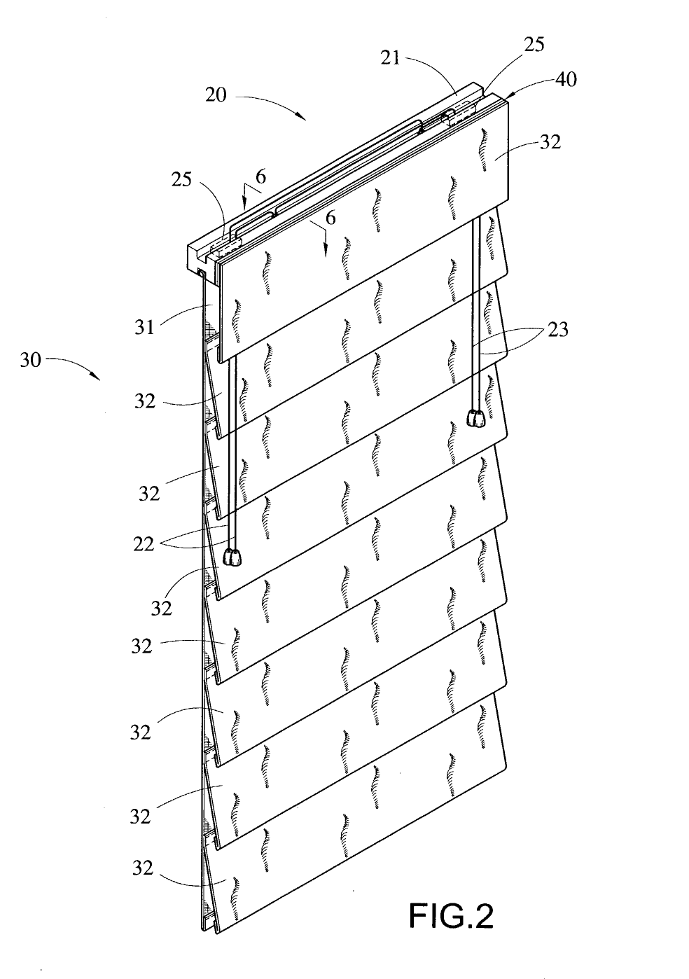

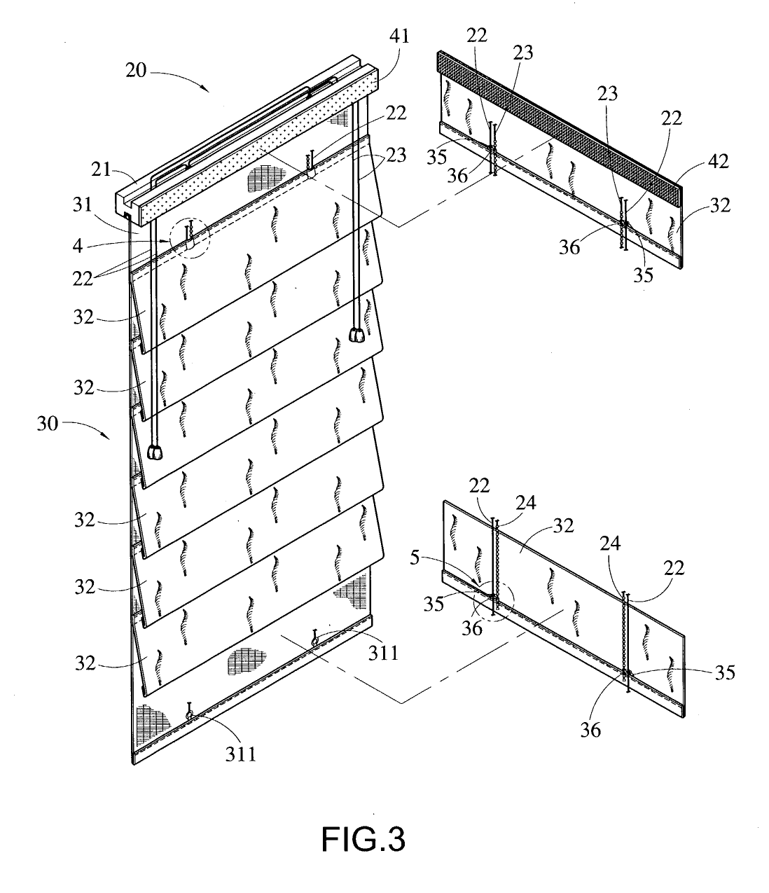

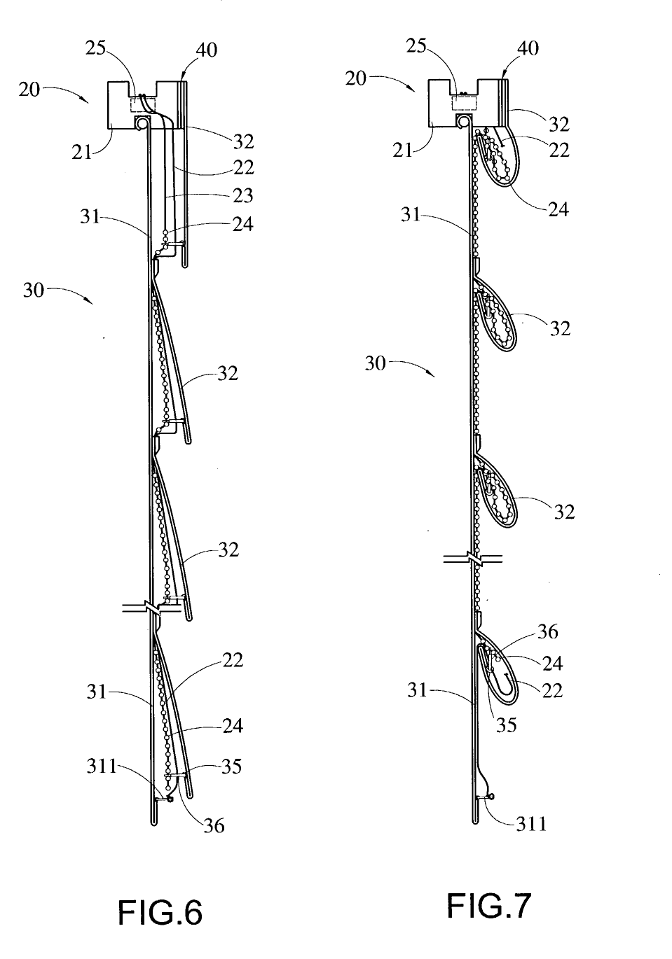

With reference to FIGS. 2-7, the double-layer drape 20 of the invention comprises an upper beam 21 and a composition of window curtain 30 to be connected to the upper beam 21. There are two sets of operating cord brake components 25 set inside the upper beam 21 to allow two operating cords 22 and 23, which have respective functions, to be pierced through within. In addition, one end of both operating cords 22 and 23 are hanging over outside the two operating cord brake components 25, respectively for a user to pull the operating cords 22 and 23. Seeing that the operating cords 22 and 23 are controlled by the operating cord brake component 25, therefore, the length of stretching the composition of window curtain 30 can be folded upwards or dropped downwards. The other end of the operating cord 23 is a beaded device 24.

The composition of window curtain 30 is formed by two kinds of curtain cloths of both inner and outer layers. The outward layer is a previous-to-light curtain 31(e.g., lace curtain); whereas the inner layer 32, which comprises a plurality of opaque curtains, are connected to the previous-to-light curtain 31 by up-and-down overlapping. In addition, the other ends of the operating cord 22 and the beaded device 24 are situated in-between the opaque curtains 31 and the inner layer 32. The previous-to-light curtain 31 with the shape of rectangle is connected the base of the upper beam 21. The top of opaque curtain 32 attaches to or separates from the upper beam 21 through a self-attached mechanism 40; other equidistant opaque curtains 32, of which each base is movable, are sewed and connected to the previous-to-light curtain 31. The self-attached mechanism 40 comprises a hook silk layer 41 integrating with the upper beam 21, besides, a nap layer 42 integrating with the top of the opaque curtain 32.

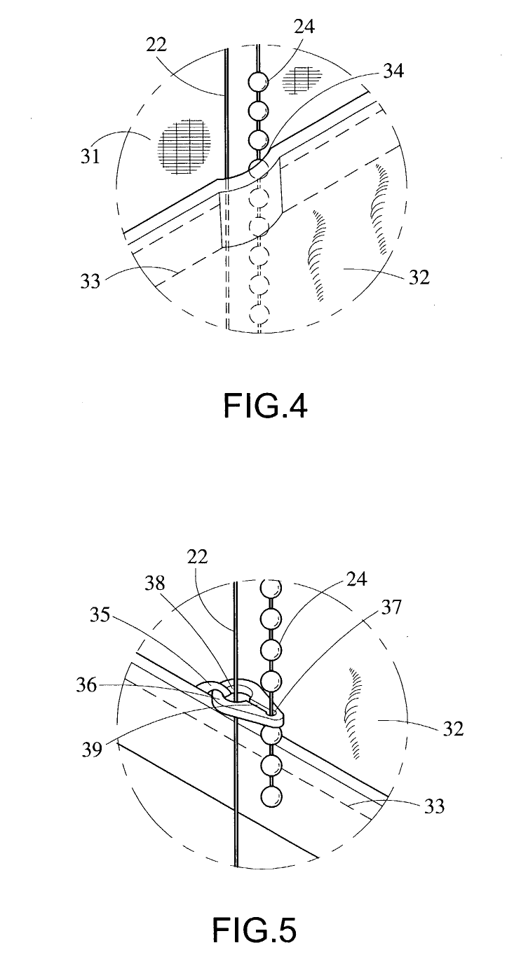

The sewing lines 33 in-between the previous-to-light curtain 31 and the opaque curtain 32 form two holes 34 (as shown in FIG. 4), which allow the operating cords 22 and 23 to pierce through for forming the connection relationships with the previous-to-light curtain 31 and the opaque curtain 32, respectively.

The base of the opaque curtain 32 forms two connected cloths 35(as shown in FIG. 5), which link to an attached ring 36, which comprises a small hole 37 and a bigger hole 38. There is a notch 39 set in between the small hole 37 and the bigger hole 38. A beaded device 24 of the operating cord 23, which is placed from a bigger hole 38 into a small hole 37 to be positioned through the notch 39, is utilized for fixing the plurality of equidistant opaque curtains 32 on the previous-to-light curtain 31; the end of the beaded device 24 is fixed in an attached ring 36 of the lowest opaque curtain 32; in addition, the bigger hole 38 enables the operating cord 22 to pierce through, the end of the operating cord 22 is fixed in an attached ring 311 at the base of the previous-to-light curtain 31. Therefore, both previous-to-light curtain 31 and the opaque curtains 32 are controlled by the operating cords 22 and 23 to be pulled upwards or downwards.

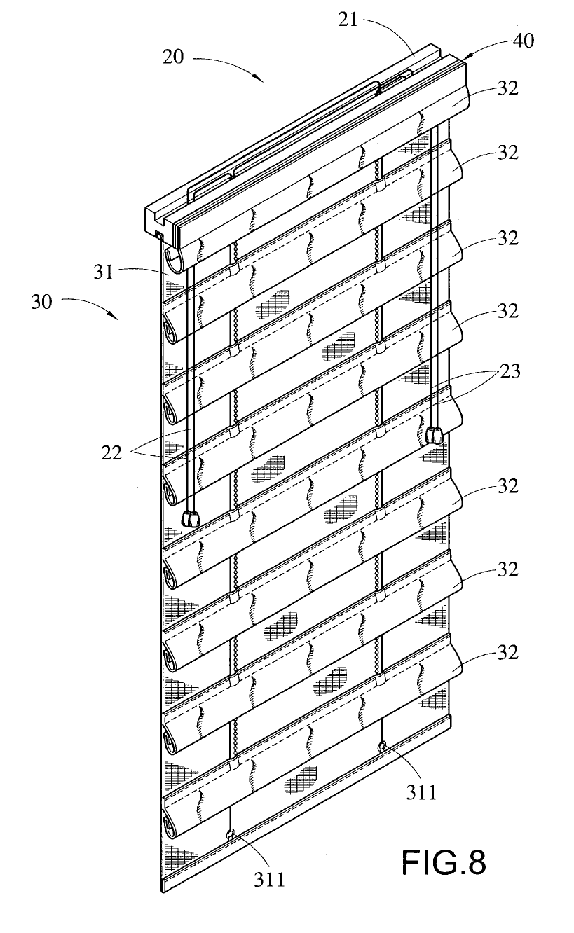

It is as shown in FIG. 8 that the base of each opaque curtain 32 is inwardly lifted following the upward movement of the beaded device 24 when the operating cord 23 is pulled downwards. Not until being pulled to an appropriate position, the operating cord 23 is then positioned by the control of the operating cord brake component. The upward movement of each opaque curtain 32 is in between the positions as shown in FIGS. 2 and 7. The invention, therefore, enables the function of semi-opaque effect in the room.

The invention enables the operating cord 23 to be an unrestrained status for moving up and down, when a swing force is exerted on the operating cord 23, hence, when the operating cord 23 is released, and the base of each opaque curtain 32 hangs over following the beaded device 24 downwards. The invention, therefore, enables the function of anti-dazzling effect inside the room; the movement is in between the positions as shown in FIGS. 8 and 2.

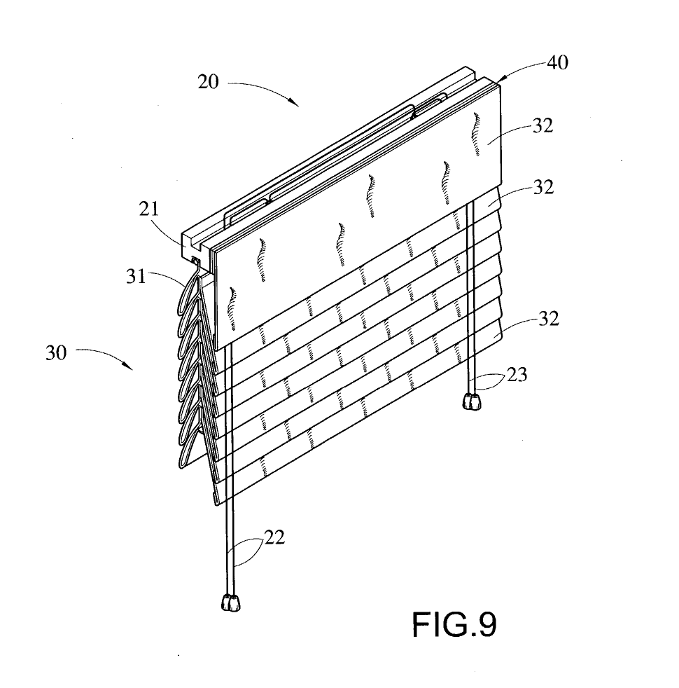

When the operating cord 22 is pulled, the composition of window curtain 30 can be folded upwards or dropped downwards; therefore, pulling the operating cord 22 upward enables the composition of window curtain 30 to be folded in-between the positions as shown in FIGS. 2 and 9. At this time, the previous-to-light curtain 31 and the opaque curtains 32 are folded upwards to enable the light to shine through in the room forming a completely well-lit effect.

In short, the composition of window curtain 30 of the invention is made of two kinds of materials forming an inner layer and an outer layer. The outer layer is a previous-to-light curtain 31; whereas the inner layer comprises a plurality of opaque curtains 32 overlapping up-and-down to be connected to the previous-to-light curtain 31. The base of each opaque curtain 32 is a moveable part, which can be folded upwards or dropped downwards through pulling the operating cord 23 by a user; therefore, when the operating cord 23 is pulled downwards, the plurality of opaque curtains 32 can be lifted and folded upwards to enable the light to shine through in the room with the anti-dazzling effect. The invention enables the operating cord 23 to be an unrestrained status for moving up and down, when a swing force is exerted on the operating cord 23, so that the plurality of opaque curtains 32 hangs over by the gravity itself; the invention, therefore, enables the function of anti-dazzling effect inside the room. In addition, the previous-to-light curtain 31 can be folded upwards or dropped downwards through pulling the operating cord 22 by a user; therefore, when the operating cord 22 is pulled downwards, the previous-to-light curtain 31 and the opaque curtains 32 are simultaneously folded upwards to enable the light to shine through in the room generating the completely well-lit effect. The composition of window curtain 30, therefore, provides different two window curtain effects at one time for meeting the requirements of modern life functions; the draper of the invention offers the enrichment a variation in the fields of both operation and light control.

It is of course to be understood that the embodiment described herein is merely illustrative of the principles of the invention and that a wide variety of modifications thereto may be effected by persons skilled in the art without departing from the spirit and scope of the invention as set forth in the following claims.

1. a double-layer drape comprising:
an upper beam having at least a operating cord brake components, which provide a set of operating cord piercing there through to enable one end of the operating cord to hang over outside the operating cord brake component for a user to pull over; and
a composition of window curtain having a previous-to-light curtain and a plurality of opaque curtain forming an inner layer and an outer layer; the outer layer is a previous-to-light curtain to connect to the upper beam; whereas the inner layer comprises a plurality of opaque curtains, are connected to the previous-to-light curtain by up-and-down overlapping, each base thereof is movable; the plurality of opaque curtain can be simultaneously folded upwards or dropped downwards through pulling the operating cord by a user.

2. The double-layer drape in accordance with claim 1, wherein the previous-to-light curtain is a lace curtain.

3. The double-layer drape in accordance with claim 1, wherein the other set of operating cord brake component enables another operating cord, with different function, to pierce there through and the end thereof connects to the base of the previous-to-light curtain; the previous-to-light curtain can be folded upwards or dropped downwards through pulling the operating cord by a user.

4. The double-layer drape in accordance with claim 1, wherein the upper beam comprises a piece of opaque curtain; the opaque curtain attaches to or separates from the upper beam is through a self-attached mechanism.

5. The double-layer drape in accordance with claim 1, wherein the previous-to-light curtain and the opaque curtain set sewing lines in-between forming at least one or above holes, which allow the operating cords with individual functions to pierce through for forming the connection relationships with the previous-to-light curtain and the opaque curtain.

6. The double-layer drape in accordance with claim 1, wherein the base of the opaque curtain comprises at least one or above connected cloths, which link to an attached ring to enable the operating cords with individual functions to pierce through.

7. The double-layer drape in accordance with claim 6, wherein the attached ring sets a bigger hole and a small hole; the holes enable the operating cords with individual functions to pierce there through.

8. The double-layer drape in accordance with claim 7, wherein the bigger hole enables an operating cord to pierce through, the end of the operating cord is fixed at the base of the previous-to-light curtain, so that the previous-to-light curtain can be folded upwards or dropped downwards through the pulling control of the operating cord.

9. The double-layer drape in accordance with claim 7, wherein the set of operating cord is a beaded device, which is equipped in the small hole of the attached ring and the end thereof is fixed at the lowest of opaque curtain to enable the plurality of opaque curtains to be simultaneously folded upwards or dropped downwards through pulling the operating cord by a user.

10. The double-layer drape in accordance with claim 7, wherein the bigger hole and the small hole have a notch in between; the notch enables the beaded device of the operating cord to slip from the bigger hole into the small hole to be equidistantly positioned at the attached ring.
